(19) United States
(12) Patent Application Publication
(10) Pub. No.: US 2013/0085631 A1
(43) Pub. Date: Apr. 4, 2013

(54) SYSTEM AND METHOD FOR CONTROLLING UPHILL DRIVING OF AN ELECTRIC VEHICLE

(71) Applicants: Sang Joon Kim, Seoul (KR); Sungdeok Kim, Sungnam (KR)

(72) Inventors: Sang Joon Kim, Seoul (KR); Sungdeok Kim, Sungnam (KR)

(73) Assignee: HYUNDAI MOTOR COMPANY, Seoul (KR)

(21) Appl. No.: 13/528,045

(22) Filed: Jun. 20, 2012

(30) Foreign Application Priority Data
Oct. 4, 2011 (KR) 10-2011-0100835

(51) Int. Cl. B60L 15/20

(52) U.S. Cl. 701/22

(57) ABSTRACT

Disclosed is a system and method that control an electric vehicle to engage a brake and to output torque of a motor after completely stopping an electric vehicle on a slope by the brake and controlling the torque of the motor to be 0 when the torque of the motor is a positive value and the velocity of the motor is a negative value when the electric vehicle is rolling backwards down a hill during uphill driving, such that safety and reliability of the electric vehicle can be improved when the electric vehicle is driving uphill on a slope.

### CROSS-REFERENCE TO RELATED APPLICATION

This application claims priority to and the benefit of Korean Patent Application No. 10-2011-0100835 filed in the Korean Intellectual Property Office on Oct. 4, 2011, the entire contents of which are incorporated herein by reference.

### BACKGROUND OF THE INVENTION

(a) Field of the Invention

The present invention relates to a system and method for controlling uphill driving of an electric vehicle. More particularly, the present invention relates to a system and method that can safely control electric vehicle stopping and driving when the electric vehicle is begins to roll backwards down a hill.

(b) Description of the Related Art

Unlike a hybrid electric vehicle (HEV) and a fuel cell electric vehicle (FCEV), an electric vehicle is structured such that power provided to the drive train of the electric vehicle comes only from an electric battery. The motor of the electric vehicle performs a regeneration operation from the driving power generated in vehicle wheels, and the battery is charged by the electric regeneration power supplied by the regeneration operation.

In electric vehicles a charging limit or a discharging limit is set for a battery to prevent an electric vehicle from exceeding an acceptable power amount because the amount of power which a battery can hold is limited.

For instance, a value of the charging power limit of the battery becomes “0” when the state of charge (SOC) of the battery is 100%, and as a result the torque of the motor is limited thereby. In this case, since the battery in an electric vehicle is in a charging state when the electric vehicle tries to restart driving uphill after stopping on a slope, the vehicle begins to roll backwards down the slope since the power to the motor is negative in these conditions.

That is, in the above case, the torque of the motor becomes a positive value and the speed of the motor becomes a negative value when a vehicle stops on a hill, and as a result the power of the motor is a negative value as well, and therefore the battery enters a charging state.

In this state, when the SOC of the battery is 100%, then the uphill driving performance of the electric vehicle is significantly degraded because the motor torque is limited since the value of the charging power limit becomes “0” as stated above. Thus, as a result the electric vehicle may roll backwards down the hill since the power provided to the motor in this instance is a negative value.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for controlling uphill driving of an electric vehicle having advantages of safely stopping and driving on a slope even when motor torque is limited by a charging power limit of the battery during uphill driving.

An exemplary embodiment of the present invention provides the method for controlling uphill driving of an electric vehicle. In one or more exemplary embodiments, the method for controlling uphill driving of an electric vehicle which includes a motor and a battery, comprising: (a) determining, by a control unit, whether a torque of the motor is a positive value and a velocity of the motor is a negative value when the battery is in a charging power limit state; (b) controlling, by the control unit, the torque of the motor to be 0 and engaging a brake when all the conditions of the step (a) are satisfied; and (c) releasing the brake and outputting the torque of the motor when the electric vehicle is stopped by activation of the brake. Subsequently the method may return to step (a) after carrying out the step (c).

In some exemplary embodiments of the present invention, the brake may be a hydraulic brake. Furthermore, the charging power limit state may be a state where a state of charge (SOC) of the battery is full and as a result the value of the charging power limit is 0. Additionally in some exemplary embodiments of the present invention, the method may further include generating a profile for controlling the operation of the brake, and the electric vehicle speed may slow down linearly to 0 based on the profile.

In another exemplary embodiment of the present invention, a system for controlling uphill driving of an electric vehicle is provided.

In one or more exemplary embodiments, the system for controlling uphill driving of an electric vehicle includes: a battery configured to provide power to the electric vehicle. A vehicle control device is configured to detect whether the electric vehicle is rolling backward down a hill during uphill driving and generates a control command for a motor and a brake. A motor control device is configured to receive the control command from the vehicle control device and control the motor accordingly. A brake control device is configured to receive the control command from the vehicle control device and control the brake accordingly. The vehicle control device controls torque of the motor to be 0 and activates the brake when the battery is in a charging power limit state, the torque of the motor is a positive value, and the velocity of the motor is a negative value, and once the vehicle has stopped, the vehicle control device releases the brake and outputs the torque of the motor.

In some exemplary embodiments the vehicle control device, the motor control device, and the brake control device may be embodied as a single control unit such as an engine control unit (ECU).

Advantageously, the illustrative embodiment of the present invention prevents the vehicle from rolling backwards on a slope by outputting an acceleration torque of the motor after the vehicle has safely stopped using an automatically applied brake.

### BRIEF DESCRIPTION OF THE DRAWINGS

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

FIG. 1 is a schematic drawing of uphill driving of the electric vehicle.

FIG. 2 is a schematic block diagram of the system for controlling uphill driving of the electric vehicle according to an exemplary embodiment of the present invention.

FIG. 3 is a flowchart of a method for controlling uphill driving of the electric vehicle according to an exemplary embodiment of the present invention.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DESCRIPTION OF SYMBOLS

10: electric vehicle
100: battery
200: vehicle control device
300: motor control device
400: brake control device

### DETAILED DESCRIPTION OF THE EMBODIMENTS

A preferred embodiment of the present invention will now be described in detail with reference to the accompanying drawings.

It is understood that the term “vehicle” or “vehicular” or other similar term as used herein is inclusive of vehicles in general such as passenger automobiles including sports utility vehicles (SUV), buses, trucks, various commercial vehicles, watercraft including a variety of boats and ships, aircraft, and the like which may be operated using purely electric power.

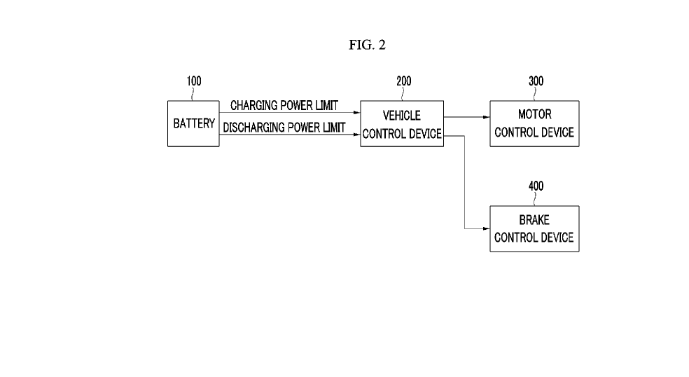

The present invention, as shown in FIG. 2, includes a battery 100 configured to provide power to the electric vehicle 10, a vehicle control device 200 configured to detect whether the electric vehicle 10 is rolling backward or going to roll backward during uphill driving and to generate control command for the motor and the brake accordingly, and a motor control device 300 and a brake control device 400 configured to control the motor and the brake respectively by receiving control commands from the vehicle control device 200.

The battery 100 provides power to the electric vehicle 10. The motor runs a regeneration operation under certain conditions so that the battery 100 is charged by the electric regeneration power supplied by the regeneration operation.

A charging power limit or a discharging power limit is set for the battery 100 to prevent the battery 100 from exceeding an acceptable charge capacity. As a result, the battery 100 enters a charging power limit state in which the value of the charging power limit is 0 when a state of charge (SOC) of the battery 100 is 100%.

When this happens, the vehicle control device 200 generates control commands for the motor and the brake. The vehicle control device 200 controls torque of the motor to be 0 and activates the brake when the electric vehicle 10 is outputting an acceleration torque when the vehicle begins or is going to roll backward down a hill while uphill driving when the battery 100 is in the charging power limit state.

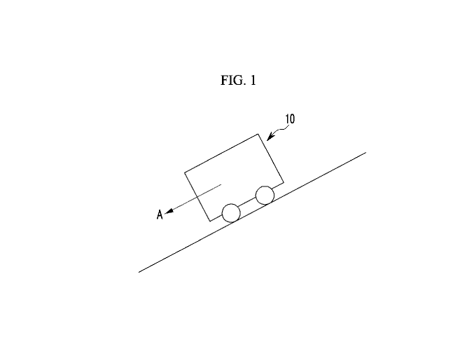

The above case, the battery 100 needs to be charged because the velocity of the motor is a negative value and the torque of the motor is a positive value thus making the power of the motor is a negative value. At this moment, when the battery 100 is in the charging power limit state due to fulfillment of the SOC, then the electric vehicle 10 may continuously roll down the slope in a direction A as shown in FIG. 1 because it is impossible for the motor to output torque in this situation.

In the illustrative embodiment of the present invention, the vehicle control device 200 generates commands to activate the hydraulic brake for completely stopping the electric vehicle 10 from continuing to roll backwards and to make the torque of the motor be 0.

The vehicle control device 200 then generates a command outputting acceleration torque of the motor after the electric vehicle 10 is completely stopped and sends the command to the motor control device 300. The motor control device 300 controls the motor to output acceleration torque so that the electric vehicle 10 can drive safely on the slope.

In some exemplary embodiments of the present invention, the brake may be a hydraulic brake. A hydraulic brake refers a brake that provides pressure to a piston of a main cylinder for generating hydraulic pressure and activates braking operations by moving a brake shoe as a resultant of the provided pressure mounted on each wheel. Advantageously, hydraulic brakes provide force distribution, ease of operation, and high efficiency. Further, hydraulic brakes may be controlled by a profile that controls the electric vehicle 10 speed to slow down linearly to 0.

Hereinafter, the method for controlling uphill driving of the electric vehicle 10 according to an exemplary embodiment of the present invention will be described.

The method for controlling uphill driving of the electric vehicle 10 may include a step of (a) determining, by the vehicle control device 200, whether torque of the motor is a positive value and velocity of the motor is a negative value when the battery 100 is in a charging power limit state, (b) controlling, by the motor control device 300, the torque of the motor to be 0 and activating, by the brake control device 400, a brake when all the conditions of the step (a) are satisfied, (c) releasing the brake and outputting the torque of the motor when the electric vehicle 10 is stopped due to activation of the brake, and (d) returning to the step (a) after carrying out the step (c).

In the step (a), the vehicle control device 200 initially determines whether the battery 100 is in a charging power limit state (S301). As mentioned above, the charging power limit state is a state where a state of charge (SOC) of the battery 100 is 100% such that the value of the charging power limit is 0.

When the battery 100 is in the charging power limit state, then the vehicle control device 200 determines whether the electric vehicle 10 is rolling backward down the hill (S302). As shown in FIG. 1, rolling backwards down the hill may be a state in which the electric vehicle 10 is rolling backward down the slope and therefore the velocity of the motor is a negative value in this situation.

When the electric vehicle 10 is rolling backward down the hill, then the vehicle control device 200 determines whether the vehicle is in a state that the acceleration torque of the motor is required by the user of the electric vehicle (S303). The state in which the acceleration torque of the motor is required may be a state in which the torque of the motor is a positive value due to a user pressing an acceleration pedal of the electric vehicle.

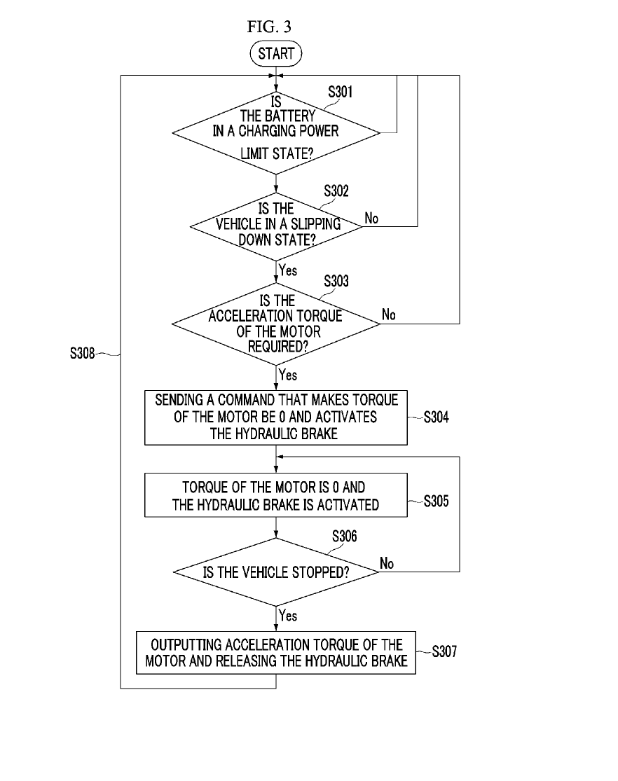

as shown in FIG. 3, the vehicle control device 200 sends a command that sets the torque of the motor be 0 to the motor control device 300 and sends a command that activates the brake (e.g., a hydraulic brake) to the brake control device 400 when the torque of the motor is a positive value in the step (a) (S304).

As stated above, the electric vehicle 10 may continuously roll backwards down the slope when the torque of the motor is limited since the battery 100 is in a charging power limit state, the torque of the motor is a positive value, and the velocity of the motor is a negative value. To prevent this, the vehicle control device 200 generates commands to stop the electric vehicle 10 using the brake so as to prevent the electric vehicle 10 from rolling backwards down the hill.

Based on commands received from the vehicle control device 200, the motor control device 300 controls torque of the motor to be 0, and the brake control device 400 controls the electric vehicle 10 to linearly slow the vehicle down by engaging the brake (S305).

As shown in FIG. 3, the vehicle control device 200 controls the vehicle to move forward (S307) by sending a command to release the brake to the brake control device 400 and sending a command to output torque from the motor to the motor control device 300 once the electric vehicle 10 is completely stopped (S306) due to activating the hydraulic brake in step (b).

The step (d) is a step that goes back to the step (a) after step (c) S308. When the electric vehicle 10 is still rolling backward down the slope despite the step (a), (b), and (c), then the torque of the motor may also be limited because it may be the case that the torque of the motor is a positive value, the velocity of the motor is a negative value, and the battery 100 is in the charging limit state. To prevent the situation that the electric vehicle 10 continuously rolls down the slope, the step (d) goes back to the step (a) after the step (c) to continuously prevent the vehicle from rolling backwards down the hill.

Advantageously, the illustrative embodiment of the present invention improves the safety of electric vehicles by preventing the electric vehicle from rolling backwards down a slope by outputting an acceleration torque from the motor after safely stopping the vehicle using the brake.

Although the above exemplary embodiment is described as using a single control unit to perform the above process, it is understood that the above processes may also be performed by a plurality of control units.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling uphill driving of an electric vehicle which includes a motor and a battery, comprising:
(a) determining, by a vehicle control device, whether a torque of the motor has a positive value and a velocity of the motor is a negative value when the battery is in a charging power limit state;
(b) controlling, by a motor control device, the torque of the motor to be 0 and engaging a brake when the torque of the motor positive, the velocity of the motor is negative and the battery is in a charging power limit state; and
(c) releasing, by a brake control device, the brake and outputting the torque of the motor when the electric vehicle is stopped due to engagement of the brake.

2. The method of claim 1, further comprising (d) returning to the step (a) after carrying out the step (c).

3. The method of claim 1, wherein the brake is a hydraulic brake.

4. The method of claim 1, wherein the charging power limit state is a state where a state of charge (SOC) of the battery is 100% and as a result a value of the charging power limit is 0.

5. The method of claim 1, further comprising generating a profile for controlling operation of the brake.

6. The method of claim 5, wherein the electric vehicle speed slows down linearly to 0 based on the profile.

7. A system for controlling uphill driving of an electric vehicle, comprising:
a battery configured to provide power to the electric vehicle;
a vehicle control device configured to detect whether the electric vehicle is rolling backwards down a hill during uphill driving and generate control commands for a motor and a brake;
a motor control device configured to receive a first control command from the vehicle control device and control the motor based on the first control command; and
a brake control device configured to receive a second control command from the vehicle control device and control the brake according to the second control command,
wherein the vehicle control device controls a torque of the motor to be 0 and engages the brake when the battery is in a charging power limit state, the torque of the motor is a positive value, and a velocity of the motor is a negative value, and
once the brake has stopped the vehicle, the vehicle control device releases the brake and outputs the torque of the motor.

8. The system of claim 7, wherein the brake is a hydraulic brake.

9. The system of claim 7, wherein the charging power limit state is a state where a state of charge (SOC) of the battery is 100% and as a result a value of the charging power limit is 0.

10. The system of claim 7, wherein the vehicle control device generates a profile for controlling the operation of the brake.

11. The system of claim 10, wherein the electric vehicle speed slows down linearly to 0 based on the profile.

12. A non-transitory computer readable medium containing program instructions executed by a control unit, the computer readable medium comprising:
program instructions that determine whether a torque of the motor has a positive value and a velocity of the motor is a negative value when the battery is in a charging power limit state;
program instructions that control the torque of the motor to be 0 and engage a brake when the torque of the motor positive, the velocity of the motor is negative and the battery is in a charging power limit state; and
program instructions that release the brake and outputting the torque of the motor when the electric vehicle is stopped due to engagement of the brake.

13. The non-transitory computer readable medium of claim 12, wherein the brake is a hydraulic brake.

14. The non-transitory computer readable medium of claim 12, wherein the charging power limit state is a state where a state of charge (SOC) of the battery is 100% and as a result a value of the charging power limit is 0.

15. The non-transitory computer readable medium of claim 12, further comprising program instructions that generate a profile for controlling the operation of the brake.

16. The non-transitory computer readable medium of claim 15, wherein the electric vehicle speed slows down linearly to 0 based on the profile.
